(19) United States
(12) Patent Application Publication
(10) Pub. No.: US 2025/0015286 A1
(43) Pub. Date: Jan. 9, 2025

(54) OXYHALIDE MATERIAL, BATTERY, AND BATTERY SYSTEM

(71) Applicant: Panasonic Intellectual Property Management Co., Ltd., Osaka (JP)

(72) Inventors: KEITA MIZUNO, Osaka (JP); YOSHIAKI TANAKA, Kyoto (JP); AKIHIRO SAKAI, Nara (JP)

(21) Appl. No.: 18/890,830

(22) Filed: Sep. 20, 2024

Related U.S. Application Data
(63) Continuation of application No. PCT/JP2023/002792, filed on Jan. 30, 2023.

(30) Foreign Application Priority Data
Apr. 6, 2022 (JP) 2022-063643

(51) Int. Cl. H01M 4/58; H01M 4/02

(52) U.S. Cl. CPC H01M 4/582; H01M 2004/028

(57) ABSTRACT

An oxyhalide material of the present disclosure contains Li, M, O, and X. M is at least two selected from Group 5 elements. X is at least one selected from the group consisting of F, Cl, Br, and I. The oxyhalide material of the present disclosure shows a reversible oxidation-reduction reaction. In an X-ray diffraction pattern obtained by X-ray diffraction measurement on the oxyhalide material using Cu-Kα radiation, at least one peak is present in a first range, and (A) or (B) below is satisfied: (A) No peak is present in a second range. (B) At least one peak is present in the second range, and a ratio of intensity Iₚ₁ of a peak with the highest intensity present in the first range to intensity Iₚ₂ of a peak with the highest intensity present in the second range Iₚ₁/Iₚ₂ is larger than 5.

### BACKGROUND

### 1. Technical Field

The present disclosure relates to an oxyhalide material, a battery, and a battery system.

### 2. Description of the Related Art

WO 2020/137153 discloses a solid electrolyte material containing Li, M, O, and X and a battery containing the same. Here M is at least one element selected from the group consisting of Nb and Ta, and X is at least one element selected from the group consisting of Cl, Br, and I.

WO 2021/075243 discloses a solid electrolyte material containing Li, M, O, X, and F and a battery containing the same. Here, M is at least one element selected from the group consisting of Ta and Nb, and X is at least one element selected from the group consisting of Cl, Br, and I.

### SUMMARY

One non-limiting and exemplary embodiment provides an oxyhalide material having practical lithium-ionic conductivity and practical electrochemical stability.

In one general aspect, the techniques disclosed here feature an oxyhalide material comprising Li, M, O, and X, M being at least two selected from Group 5 elements, X being at least one selected from the group consisting of F, Cl, Br, and I, and the oxyhalide material showing a reversible oxidation-reduction reaction, wherein in an X-ray diffraction pattern obtained by X-ray diffraction measurement on the oxyhalide material using Cu-Kα radiation, when a range with a diffraction angle 2θ of greater than or equal to 13.0° and less than or equal to 14.5° is defined as a first range, at least one peak is present in the first range, and in the X-ray diffraction pattern, when a range with a diffraction angle 2θ of greater than or equal to 10.0° and less than or equal to 11.9° is defined as a second range, (A) or (B) below is satisfied: (A) No peak is present in the second range. (B) At least one peak is present in the second range, and a ratio of intensity Iₚ₁ of a peak with the highest intensity present in the first range to intensity Iₚ₂ of a peak with the highest intensity present in the second range Iₚ₁/Iₚ₂ is larger than 5.

The present disclosure provides an oxyhalide material having practical lithium-ionic conductivity and practical electrochemical stability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view of a schematic configuration of a battery according to a second embodiment;

FIG. 2 is a schematic diagram of a molding die used for evaluating the ionic conductivity of an oxyhalide material;

FIG. 3 is a graph of a Cole-Cole plot obtained by electrochemical impedance measurement on an oxyhalide material of Example 1-1;

FIG. 4A is a graph of an X-ray diffraction patterns of oxyhalide materials of examples and comparative examples;

FIG. 4B is an enlarged view of the first range in FIG. 4A;

FIG. 5 is a graph of cyclic voltammograms at a second cycle and a third cycle obtained by cyclic voltammetric (CV) measurement on the oxyhalide material of Example 1-1;

FIG. 6 is a graph of X-ray diffraction patterns of the oxyhalide material of Example 1-1 before and after performing the CV measurement on 11 cycles;

FIG. 7A is a graph of discharge characteristics of batteries of Example 2-1 and Comparative Example 2-1 at a first cycle;

FIG. 7B is a graph of discharge characteristics of the batteries of Example 2-1 and Comparative Example 2-1 at a second cycle; and

FIG. 8 is a graph of discharge characteristics of a battery of Example 3-1 at a first cycle and a 50th cycle.

### DETAILED DESCRIPTIONS

### Underlying Knowledge Forming Basis of the Present Disclosure

WO 2020/137153 discloses a solid electrolyte material containing Li, M, O, and X (M is at least one element selected from the group consisting of Nb and Ta, and X is at least one element selected from the group consisting of Cl, Br, and I). WO 2021/075243 discloses a solid electrolyte material containing Li, M, O, X, and F (M is at least one element selected from the group consisting of Ta and Nb, and X is at least one element selected from the group consisting of Cl, Br, and I).

The solid electrolyte materials disclosed in WO 2020/137153 and WO 2021/075243 contain Ta or Nb, which is a transition metal element. When a material containing a transition metal element is exposed to a potential near the reduction potential of transition metal ions, the transition metal ions are reduced, and thus the material may be decomposed or undergo a structural change. Thus, when the solid electrolyte materials are exposed to a potential less than or equal to the reduction potential, lithium-ionic conductivity can markedly decrease.

WO 2021/075243 discloses that when the molar ratio of F to the total of X and F is greater than or equal to 10% and less than or equal to 50%, the reduction potential of the solid electrolyte material decreases. Specifically, WO 2021/075243 discloses that in a material containing Li, Ta, O, Cl, and F, the reduction potential at 25° C. when the molar ratio of F to the total of X and F is 10% is 2.2 V (to the standard electrode potential of Li metal) and the reduction potential at 25° C. when the molar ratio of F to the total of X and F is 50% is 2.0 V. Thus, the reduction potential of the solid electrolyte material decreases as the molar ratio of F to the total of X and F increases.

To improve the charge-discharge characteristics of a battery, an electrolyte material for use in the battery is required to have high electrochemical stability in addition to high lithium-ionic conductivity.

High lithium-ionic conductivity is required to reduce the internal resistance of the battery. In particular, it can be said that, as an example, the electrolyte material having a lithium-ionic conductivity of greater than or equal to 1.0×10⁻³ S/cm around room temperature has sufficient lithium-ionic conductivity for the reduction of the internal resistance of the battery.

High electrochemical stability is required to inhibit the decomposition of the electrolyte material and to hold high lithium-ionic conductivity. The reduction potential of the electrolyte material changes depending on the operating potential of a battery, potential distribution within the battery, and temperature changes of the battery. Thus, when being used as an electrolyte material within a positive electrode, the reduction potential of the electrolyte material is preferably, for example, less than or equal to 2.2 V. When being used within a low-potential negative electrode or as a separator layer of the battery, the reduction potential of the electrolyte material is preferably, for example, less than or equal to 1.5 V.

The solid electrolyte materials disclosed in WO 2020/137153 and WO 2021/075243 cannot achieve both sufficiently high lithium-ionic conductivity and sufficiently high electrochemical stability. That is, the solid electrolyte materials disclosed in WO 2020/137153 and WO 2021/075243 cannot achieve both lithium-ionic conductivity being greater than or equal to 1.0×10⁻³ S/cm around room temperature and the reduction potential being less than or equal to 2.2 V or less than or equal to 1.5 V.

The present inventors have earnestly studied in order to actualize an oxyhalide material having practical lithium-ionic conductivity and practical electrochemical stability to think of the oxyhalide material of the present disclosure.

### Summary of Aspect according to Present Disclosure

An oxyhalide material according to a first aspect of the present disclosure comprises Li, M, O, and X,
M being at least two selected from Group 5 elements,
X being at least one selected from the group consisting of F, Cl, Br, and I, and
the oxyhalide material showing a reversible oxidation-reduction reaction, wherein
in an X-ray diffraction pattern obtained by X-ray diffraction measurement on the oxyhalide material using Cu-Kα radiation, when a range with a diffraction angle 2θ of greater than or equal to 13.0° and less than or equal to 14.5° is defined as a first range, at least one peak is present in the first range, and
in the X-ray diffraction pattern, when a range with a diffraction angle 2θ of greater than or equal to 10.0° and less than or equal to 11.9° is defined as a second range, (A) or (B) below is satisfied:
(A) No peak is present in the second range.
(B) At least one peak is present in the second range, and a ratio of intensity Iₚ₁ of a peak with the highest intensity present in the first range to intensity Iₚ₂ of a peak with the highest intensity present in the second range Iₚ₁/Iₚ₂ is larger than 5.

The oxyhalide material of the present disclosure has practical lithium-ionic conductivity and practical electrochemical stability.

In a second aspect of the present disclosure, for example, in the oxyhalide material according to the first aspect, M may comprise Nb. The above configuration more improves the electrochemical stability of the oxyhalide material.

In a third aspect of the present disclosure, for example, in the oxyhalide material according to the first aspect or the second aspect, M may comprise Nb and Ta. The above configuration more improves the lithium-ionic conductivity of the oxyhalide material.

In a fourth aspect of the present disclosure, for example, in the oxyhalide material according to any one of the first to third aspects, X may be at least two selected from the group consisting of F, Cl, Br, and I. The above configuration more improves the electrochemical stability of the oxyhalide material.

In a fifth aspect of the present disclosure, for example, in the oxyhalide material according to the fourth aspect, X may comprise F and Cl. The above configuration more improves the electrochemical stability of the oxyhalide material.

In a sixth aspect of the present disclosure, for example, in the oxyhalide material according to any one of the first to fifth aspects, when cyclic voltammetric measurement is performed using the oxyhalide material as a working electrode, in a range of greater than or equal to 1.5 V and less than or equal to 4.5 V to a standard electrode potential of Li metal, a total current amount at a third cycle to a total current amount at a second cycle may be greater than 90% and less than 110%. The above configuration provides the oxyhalide material with high electrochemical stability.

In a seventh aspect of the present disclosure, for example, in the oxyhalide material according to any one of the first to fifth aspects, when cyclic voltammetric measurement is performed using the oxyhalide material as a working electrode, in a range of greater than or equal to 1.5 V and less than or equal to 3.5 V to a standard electrode potential of Li metal, a total current amount at a third cycle to a total current amount at a second cycle may be greater than 90% and less than 110%. The above configuration makes it easy for the oxyhalide material to achieve high electrochemical stability in addition to high lithium-ionic conductivity.

In an eighth aspect of the present disclosure, for example, in the oxyhalide material according to any one of the first to seventh aspects, M may comprise Nb, X may comprise F, a molar ratio of Nb to M may be greater than or equal to 0.50 and less than or equal to 0.70, and a molar ratio of F to X may be greater than or equal to 0.02 and less than or equal to 0.08. The above configuration improves the lithium-ionic conductivity of the oxyhalide material.

In a ninth aspect of the present disclosure, for example, in the oxyhalide material according to the eighth aspect, a molar ratio of Nb to M may be greater than or equal to 0.55 and less than or equal to 0.60. The above configuration further improves the reversibility of the oxidation-reduction reaction of the oxyhalide material.

A battery according to a 10th aspect of the present disclosure comprises:
a positive electrode;
a negative electrode; and
an electrolyte layer provided between the positive electrode and the negative electrode, wherein
at least one selected from the group consisting of the positive electrode, the negative electrode, and the electrolyte layer comprises the oxyhalide material according to any one of the first to ninth aspects.

The battery according to the present disclosure has excellent charge-discharge characteristics.

In an 11th aspect of the present disclosure, for example, in the battery according to the 10th aspect, at least one selected from the group consisting of the positive electrode and the negative electrode may comprise the oxyhalide material. The above configuration can achieve excellent charge-discharge characteristics.

In a 12th aspect of the present disclosure, for example, in the battery according to the 11th aspect, at least one selected from the group consisting of the positive electrode and the negative electrode may comprise the oxyhalide material as an active material and does not necessarily comprise any active materials other than the oxyhalide material. The above configuration can improve the energy density of the battery.

A battery system according to a 13th aspect of the present disclosure comprises the battery according to any one of the 10th to 12th aspects, wherein
a potential limit for discharge of the battery is less than or equal to 3.0 V to a standard electrode potential of Li metal.

The battery system of the present disclosure can improve the charge-discharge capacity and the energy density of the battery.

The following describes embodiments of the present disclosure with reference to the accompanying drawings.

### First Embodiment

An oxyhalide material according to a first embodiment contains Li, M, O, and X. M is at least two selected from Group 5 elements. X is at least one selected from the group consisting of F, Cl, Br, and I. The oxyhalide material according to the first embodiment shows a reversible oxidation-reduction reaction. Note that the Group 5 elements are V, Nb, Ta, and Db.

The oxyhalide material according to the first embodiment has practical lithium-ionic conductivity and practical electrochemical stability. The oxyhalide material according to the first embodiment has high lithium-ionic conductivity. Here, the high lithium-ionic conductivity is, for example, greater than or equal to 1.0×10⁻³ S/cm around room temperature. That is, a solid electrolyte material according to the first embodiment can have a lithium-ionic conductivity of greater than or equal to 1.0×10⁻³ S/cm. The oxyhalide material according to the first embodiment shows a reversible oxidation-reduction reaction and can thus have high electrochemical stability.

The oxyhalide material according to the first embodiment can be used not only as an electrolyte but also as an active material in a battery. The active material is a material having characteristics occluding and releasing metal ions.

Here, the oxyhalide material “showing a reversible oxidation-reduction reaction” means that it can reversibly occlude and release Li. For example, in a system containing the oxyhalide material according to the first embodiment and a separate Li source, even when the oxyhalide material receives an electron (e⁻) to be electrochemically reduced and changes in its composition, it can electrochemically oxidize through a reverse reaction to revert to the original composition. In this example, the order of reduction and oxidation may be reversed.

Concerning the oxidation-reduction reaction of the oxyhalide material according to the first embodiment, for example, Reaction Formula (1) below holds.

Li⁺M^{+V}OX₄+Li+e⁻⇔Li₂M^{+IV}OX₄ Formula (1)

Here, M^{+V} represents a +5-valent transition metal ion, M^{+IV} represents a +4-valent transition metal ion formed by the reduction of M^{+V}, and X represents a halide ion. The double-pointed arrow “⇔” means that the oxidation-reduction reaction proceeds reversibly.

Reaction Formula (1) represents that the composition represented by Li⁺M^{+V}OX₄ changes to the composition represented by Li₂M^{+IV}OX₄ or vice versa through the oxidation-reduction reaction via occlusion and release of Li.

In Reaction Formula (1), Li⁺M^{+V}OX₄ may have the same crystalline structure as that of Li₂M^{+IV}OX₄ or have a different crystalline structure therefrom. To increase electrochemical stability, Li⁺M^{+V}OX₄ may have the same crystalline structure as that of Li₂M^{+IV}OX₄.

Thus, the oxyhalide material according to the first embodiment shows a reversible oxidation-reduction reaction. Thus, even when being exposed to a potential less than or equal to a reduction potential and decomposition or a structural change occurs, the oxyhalide material according to the first embodiment can revert to the state before decomposition or a structural change occurs by being exposed to a potential greater than or equal to the reduction potential. That is, even when lithium-ionic conductivity decreases by reduction, lithium-ionic conductivity can be restored by oxidation. Thus, the oxyhalide material according to the first embodiment has high stability against external electrochemical influences.

The means for observing the reversibility of the oxidation-reduction reaction of the oxyhalide material is not particularly limited. For example, the reversibility of the oxidation-reduction reaction can be evaluated by performing cyclic voltammetric measurement (hereinafter referred to as “CV measurement”) with the oxyhalide material used as a working electrode and with a material that can occlude and release lithium as a counter electrode. Specifically, the reversibility of the oxidation-reduction reaction can be observed by performing the CV measurement on a plurality of cycles and measuring a change in a current amount when the oxyhalide material is electrochemically oxidized and reduced. Alternatively, the reversibility of the oxidation-reduction reaction can be observed from the similarity of diffraction patterns obtained by performing X-ray diffraction measurement before and after the oxyhalide material is oxidized and reduced.

The oxyhalide material according to the first embodiment may be a single compound or is not necessarily a single compound.

The oxyhalide material according to the first embodiment can be used to obtain a battery having excellent charge-discharge characteristics. Examples of the battery include all-solid-state batteries. The battery may be a primary battery or a secondary battery.

The oxyhalide material according to the first embodiment does not desirably contain sulfur. A material that does not contain sulfur does not produce hydrogen sulfide even when being exposed to the atmosphere and thus has excellent safety.

To increase lithium-ionic conductivity, the oxyhalide material according to the first embodiment may consist essentially of Li, M, O, and X. Here, the oxyhalide material “consisting essentially of Li, M, O, and X” means that the molar ratio (that is, the molar fraction) of the total of the substance amounts of Li, M, O, and X to the total of the substance amounts of all the elements constituting the oxyhalide material is greater than or equal to 90%. As an example, the molar ratio may be greater than or equal to 95%. The oxyhalide material according to the first embodiment may consist only of Li, M, O, and X.

The oxyhalide material according to the first embodiment may contain elements inevitably mixed in. Examples of the elements include hydrogen and nitrogen. Such elements can exist in raw material powders of the solid electrolyte material or an atmosphere for producing or storing the solid electrolyte material.

To increase the electrochemical stability of the oxyhalide material more, M may contain Nb.

To increase the lithium-ionic conductivity of the oxyhalide material more, M may contain Nb and Ta.

To increase the electrochemical stability of the oxyhalide material more, X may be at least two selected from the group consisting of F, CI, Br, and I.

To increase the electrochemical stability of the oxyhalide material more, X may contain F and Cl.

The oxyhalide material according to the first embodiment may be crystalline. An X-ray diffraction pattern of the oxyhalide material according to the first embodiment can be acquired by X-ray diffraction measurement by the θ-2θ method using Cu-Kα radiation (wavelengths of 1.5405 Å and 1.5444 Å, that is, wavelengths of 0.15405 nm and 0.15444 nm). In the obtained X-ray diffraction pattern, when a range with a diffraction angle 2θ of greater than or equal to 13.0° and less than or equal to 14.5° is defined as a first range, at least one peak is present in the first range. A crystalline phase in which a peak is present in the first range has a one-dimensional chain structure. With this, cations of a Group 5 clement (that is, M) are oxidized and reduced while the one-dimensional chain structure is maintained and Li can be reversibly extracted and inserted from and into the one-dimensional chain structure. Thus, the reversibility of the oxidation-reduction reaction of the oxyhalide material increases, and higher electrochemical stability can be achieved.

In the above X-ray diffraction pattern, when a range with a diffraction angle 2θ of greater than or equal to 10.0° and less than or equal to 11.9° is defined as a second range, no peak may be present in the second range. A crystalline phase having a peak in the second range has lower reversibility of the oxidation-reduction reaction than that of the crystalline phase having a peak in the first range. Thus, when no peak is present in the second range, even higher electrochemical stability can be achieved.

In the above X-ray diffraction pattern, at least one peak may be present in the second range. In this case, the ratio of intensity Iₚ₁ of a peak with the highest intensity present in the first range to intensity Iₚ₂ of a peak with the highest intensity present in the second range Iₚ₁/Iₚ₂ may be larger than 5. This means that the content of the crystalline phase having a peak in the first range, which has high reversibility of the oxidation-reduction reaction, is sufficiently larger than the content of the crystalline phase having a peak in the second range. Thus, even higher electrochemical stability can be achieved.

The oxyhalide material according to the first embodiment may be amorphous.

The oxyhalide material according to the first embodiment may have both crystalline and amorphous properties. Here, being crystalline refers to the presence of a peak in an X-ray diffraction pattern. Being amorphous refers to the presence of a broad peak (that is, a halo) in an X-ray diffraction pattern. In the case of being amorphous and crystalline in a mixed manner, a peak and a halo are present in an X-ray diffraction pattern.

A cyclic voltammogram of the oxyhalide material according to the first embodiment can be acquired by the CV measurement using the oxyhalide material as a working electrode and using a material occluding and releasing lithium ions (for example, Li metal) as a counter electrode. In a cyclic voltammogram of the oxyhalide material obtained in a range of greater than or equal to 1.5 V and less than or equal to 4.5 V to the standard electrode potential of Li metal, a total current amount at a third cycle to a total current amount at a second cycle may be greater than 90% and less than 110%. With the above configuration, the oxyhalide material has high electrochemical stability.

In a reaction at a first cycle of the CV measurement, an interfacial film forming reaction can conspicuously occur between members for use in the measurement. Thus, a total current amount at the first cycle can contain a current caused by reactions other than the oxidation-reduction reaction of the oxyhalide material. Thus, in the present embodiment, the total current amount at the first cycle is not considered in order to focus on the oxidation-reduction reaction of the oxyhalide material.

In a cyclic voltammogram of the oxyhalide material obtained in a range of greater than or equal to 1.5 V and less than or equal to 3.5 V to the standard electrode potential of Li metal, a total current amount at a third cycle to a total current amount at a second cycle may be greater than 90% and less than 110%. With the above configuration, the oxyhalide material easily achieves high electrochemical stability in addition to high lithium-ionic conductivity.

When M contains Nb and X contains F, the molar ratio of Nb to M may be greater than or equal to 0.50 and less than or equal to 0.70 and the molar ratio of F to X may be greater than or equal to 0.02 and less than or equal to 0.08. The above configuration optimizes a lithium-ion conduction path in the oxyhalide material. Thus, the lithium-ionic conductivity of the oxyhalide material improves.

The upper limit value and the lower limit value of the molar ratio of F to X may be prescribed by any combination selected from values of 0.02, 0.04, and 0.08.

The upper limit value and the lower limit value of the molar ratio of Nb to M may be prescribed by any combination selected from values of 0.50, 0.55, 0.60, and 0.70.

When M contains Nb, the molar ratio of Nb to M may be greater than or equal to 0.55 and less than or equal to 0.60. The above configuration makes the one-dimensional chain structure of the oxyhalide material of the first embodiment remarkably strong. Thus, the reversibility of the oxidation-reduction reaction of the oxyhalide material further improves.

The shape of the oxyhalide material according to the first embodiment is not particularly limited. Examples of the shape include a needle shape, a spherical shape, and an elliptic spherical shape. The oxyhalide material according to the first embodiment may be particles. The oxyhalide material according to the first embodiment may be formed so as to have a pellet or plate shape.

When the shape of the oxyhalide material according to the first embodiment is, for example, a particle shape (for example, a spherical shape), the oxyhalide material may have a median diameter of greater than or equal to 0.1 μm and less than or equal to 100 μm. The median diameter means a particle diameter when a cumulative volume in a volume-based particle size distribution is equal to 50%. The volume-based particle size distribution is measured by, for example, a laser diffraction type measurement apparatus or an image analysis apparatus.

The oxyhalide material according to the first embodiment may have a median diameter of greater than or equal to 0.5 μm and less than or equal to 10 μm. With this, the oxyhalide material according to the first embodiment has higher lithium-ionic conductivity. Furthermore, when the oxyhalide material according to the first embodiment is mixed with another material, the oxyhalide material according to the first embodiment and the other material can be well dispersed with each other.

### Method for Producing Oxyhalide Material

The oxyhalide material according to the first embodiment can be produced by, for example, the following method.

First, two or more raw material powders are mixed together so as to have an objective composition. Examples of the raw material powders include oxides, hydroxides, halides, and acid halides.

As an example, in the oxyhalide material containing Li, Ta, Nb, O, Cl, and F, when the molar ratios of Li/M, O/X, Nb/M, and F/X at the time of mixing the raw materials are 1.2, 0.24, 0.50, and 0.04, respectively, Li₂O₂, TaCl₅, TaF₅, and NbCl₅ are mixed together so as to have a molar ratio of 0.60:0.46:0.04:0.50.

By selecting the type of the raw material powders, the element type of M and X is determined. By selecting the mixing ratio of the raw material powders, the molar ratio of the elements is determined.

The raw material powders may be mixed together with a molar ratio adjusted in advance so as to cancel composition changes that can occur in a synthesis process.

Next, the raw material powders are mechanochemically reacted with each other in a mixing device such as a planetary ball mill to obtain a reaction product. That is, the raw material powders are mixed and reacted with each other using a method of mechanochemical milling. The thus obtained reaction product may be further heat-treated in an inert gas atmosphere or in a vacuum.

Alternatively, a mixture of the raw material powders may be heat-treated in an inert gas atmosphere to be reacted with each other and to obtain a reaction product. Examples of the inert gas include helium, nitrogen, and argon. The heat treatment may be performed in a vacuum. In the heat treatment step, the mixture of the raw material powders may be put in a container (for example, a crucible, a hermetically sealed container, and a vacuum sealed tube) to be heat-treated in a heating furnace.

By these methods, the oxyhalide material according to the first embodiment is obtained.

The composition of the oxyhalide material is determined by, for example, an ICP emission spectrometric method, an ion chromatographic method, an inert gas fusion-infrared absorption method, or an electron probe microanalyzer method.

### Second Embodiment

The following describes a second embodiment. The matter described in the first embodiment can be omitted.

Described in the second embodiment are a battery containing the oxyhalide material according to the first embodiment and a battery system including the battery.

The battery according to the second embodiment includes a positive electrode, a negative electrode, and an electrolyte layer. The electrolyte layer is provided between the positive electrode and the negative electrode. At least one selected from the group consisting of the positive electrode, the negative electrode, and the electrolyte layer contains the oxyhalide material according to the first embodiment.

In the battery according to the second embodiment, at least one selected from the group consisting of the positive electrode and the negative electrode may contain the oxyhalide material according to the first embodiment.

The battery according to the second embodiment contains the oxyhalide material according to the first embodiment and thus has excellent charge-discharge characteristics.

The battery may be an all-solid-state battery.

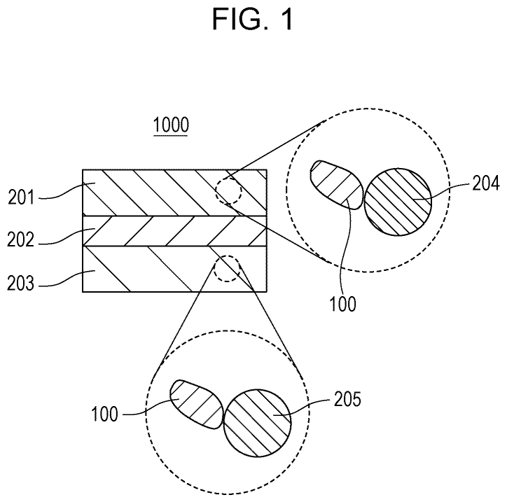

FIG. 1 is a sectional view of a schematic configuration of a battery 1000 according to the second embodiment.

The battery 1000 according to the second embodiment includes a positive electrode 201, an electrolyte layer 202, and a negative electrode 203. The electrolyte layer 202 is provided between the positive electrode 201 and the negative electrode 203.

The positive electrode 201 contains positive electrode active material particles 204 and solid electrolyte particles 100.

The electrolyte layer 202 contains an electrolyte material. The electrolyte material is, for example, a solid electrolyte material.

The negative electrode 203 contains negative electrode active material particles 205 and the solid electrolyte particles 100.

The solid electrolyte particles 100 may be particles containing the oxyhalide material according to the first embodiment or particles containing the oxyhalide material according to the first embodiment as a main component. Here, the “particles containing the oxyhalide material according to the first embodiment as a main component” means particles with a component contained the most in terms of molar ratio being the oxyhalide material according to the first embodiment.

When having the above configuration, the solid electrolyte particles 100 have higher lithium-ionic conductivity.

The solid electrolyte particles 100 may be particles containing a different material from the oxyhalide material according to the first embodiment or solid electrolyte particles containing a material other than the oxyhalide material according to the first embodiment as a main component. The solid electrolyte is called a second solid electrolyte. That is, the solid electrolyte particles 100 may contain the second solid electrolyte.

The second solid electrolyte may be a sulfide solid electrolyte, an oxide solid electrolyte, a halide solid electrolyte, a polymeric solid electrolyte, or a complex hydride solid electrolyte.

In the present disclosure, the “sulfide solid electrolyte” means a solid electrolyte containing sulfur. The “oxide solid electrolyte” means a solid electrolyte containing oxygen and containing neither sulfur nor a halogen element. The “halide solid electrolyte” means a solid electrolyte containing a halogen element and not containing sulfur. The halide solid electrolyte may contain oxygen.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

To the sulfide solid electrolyte, LiX, Li₂O, MO_{q}, LiₚMO_{q}, or the like may be added. X in “LiX” is at least one element selected from the group consisting of F, Cl, Br, and I. M in “MO_{q}” and “LiₚMO_{q}” is at least one element selected from the group consisting of P, Si, Ge, B, Al, Ga, In, Fe, and Zn. The letters p and q in “MO_{q}” and “LiₚMO_{q}” are each independently a natural number.

Examples of the oxide solid electrolyte include NASICON type solid electrolytes such as LiTi₂(PO₄)₃ and element-substituted products thereof, perovskite type solid electrolytes such as (La,Li)TiO₃, LISICON type solid electrolytes such as Li₁₄ZnGe₄O₁₆, Li₄SiO₄, and LiGeO₄ and element-substituted products thereof, garnet type solid electrolytes such as Li₇La₃Zr₂O₁₂ and element-substituted products thereof, Li₃PO₄ and N-substituted products thereof, and glasses or glass ceramics with Li—B—O compounds such as LiBO₂ and Li₃BO₃ as base materials and with materials such as Li₂SO₄ and Li₂CO₃ added.

Examples of the halide solid electrolyte include compounds represented by LiₐMe_{b}Y_{c}X₆. Here, a+mb+3c=6 and c>0 are satisfied, Me is at least one selected from the group consisting of metal elements other than Li and Y and semi-metal elements, and m represents the valence of Me. Note that the “semi-metal elements” are B, Si, Ge, As, Sb, and Te. The “metal elements” are all the elements included in Group 1 to Group 12 of the periodic table (but excluding hydrogen) and all the elements included in Group 13 to Group 16 of the periodic table (but excluding B, Si, Ge, As, Sb, Te, C, N, P, O, S, and Se). That is, the “metal elements” are an element group that can be cations when forming inorganic compounds with halogen compounds. For Me, at least one element selected from the group consisting of Mg, Ca, Sr, Ba, Zn, Sc, Al, Ga, Bi, Zr, Hf, Ti, Sn, Ta, and Nb may be used. Li₃YCl₆, Li₃YBr₆, or the like can be used.

Examples of the polymeric solid electrolyte include compounds of a polymer compound and a lithium salt. The polymer compound may have an ethylene oxide structure. The polymer compound having an ethylene oxide structure can contain the lithium salt in large amount and can thus increase lithium-ionic conductivity more. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, one lithium salt selected from these may be used singly or a mixture of two or more lithium salts selected from these may be used.

Examples of the complex hydride solid electrolyte include LiBH₄—LiI and LiBH₄—P₂S₅.

The solid electrolyte particles 100 may have a median diameter of greater than or equal to 0.1 μm and less than or equal to 100 μm. When having a median diameter of greater than or equal to 0.5 μm and less than or equal to 10 μm, the solid electrolyte particles 100 have higher ionic conductivity.

The positive electrode 201 contains a material that can occlude and release metal ions (for example, lithium ions). The material is, for example, a positive electrode active material (for example, the positive electrode active material particles 204), which is a material that can occlude and release metal ions.

The positive electrode active material particles 204 may be particles containing the oxyhalide material according to the first embodiment or particles containing the oxyhalide material according to the first embodiment as a main component.

When having the above configuration, the battery 1000 has high energy density.

The positive electrode active material particles 204 may be particles containing a different material from the oxyhalide material according to the first embodiment or positive electrode active material particles containing a material other than the oxyhalide material according to the first embodiment as a main component. The positive electrode active material is called a second positive electrode active material. That is, the positive electrode active material particles 204 may contain the second positive electrode active material.

Examples of the second positive electrode active material include lithium-containing transition metal oxides, transition metal fluorides, polyanionic materials, fluorinated polyanionic materials, transition metal sulfides, transition metal oxyfluorides, transition metal oxysulfides, and transition metal oxynitrides. Examples of the lithium-containing transition metal oxides include Li(Ni,Co,Al)O₂ and LiCoO₂.

In the present disclosure, the expression “(A,B,C)” in chemical formulae means “at least one selected from the group consisting of A, B, and C.” For example, “(Ni,Co,Al)” has the same meaning as “at least one selected from the group consisting of Ni, Co, and Al.”

As the positive electrode active material particles 204, a mixture of particles containing the oxyhalide material according to the first embodiment and particles containing the second positive electrode active material may be used.

The positive electrode active material particles 204 may have a median diameter of greater than or equal to 0.1 μm and less than or equal to 100 μm. When the positive electrode active material particles 204 have a median diameter of greater than or equal to 0.1 μm, the positive electrode active material particles 204 and the solid electrolyte particles 100 can be well dispersed in the positive electrode 201. This improves the charge-discharge characteristics of the battery 1000. When the positive electrode active material particles 204 have a median diameter of less than or equal to 100 μm, a lithium diffusion rate within the positive electrode active material particles 204 improves. This can cause the battery 1000 to operate at high output.

The positive electrode active material particles 204 may have a larger median diameter larger than that of the solid electrolyte particles 100. With this, the positive electrode active material particles 204 and the solid electrolyte particles 100 can be well dispersed in the positive electrode 201.

To increase the energy density and the output of the battery 1000, in the positive electrode 201, the ratio of the volume of the positive electrode active material particles 204 to the total of the volume of the positive electrode active material particles 204 and the volume of the solid electrolyte particles 100 may be greater than or equal to 0.30 and less than or equal to 0.95.

To increase the energy density and the output of the battery 1000, the positive electrode 201 may have a thickness of greater than or equal to 10 μm and less than or equal to 500 μm.

The electrolyte layer 202 contains an electrolyte material. The electrolyte material is, for example, the oxyhalide material according to the first embodiment. The electrolyte layer 202 may be a solid electrolyte layer.

The electrolyte layer 202 may contain only the oxyhalide material according to the first embodiment. Alternatively, the electrolyte layer 202 may contain only the second solid electrolyte, which is different from the oxyhalide material according to the first embodiment.

The electrolyte layer 202 may contain not only the oxyhalide material according to the first embodiment but also a second solid electrolyte material. In the electrolyte layer 202, the oxyhalide material according to the first embodiment and the second solid electrolyte material may be uniformly dispersed. A layer containing the oxyhalide material according to the first embodiment and a layer containing the second solid electrolyte material may be stacked on each other along a stacking direction of the battery 1000.

The electrolyte layer 202 may have a thickness of greater than or equal to 1 μm and less than or equal to 1000 μm. When the electrolyte layer 202 has a thickness of greater than or equal to 1 μm, the positive electrode 201 and the negative electrode 203 are difficult to be short-circuited. When the electrolyte layer 202 has a thickness of less than or equal to 1000 μm, the battery 1000 can operate at high output.

The negative electrode 203 contains a material that can occlude and release metal ions (for example, lithium ions). The material is, for example, a negative electrode active material (for example, the negative electrode active material particles 205), which is a material that can occlude and release metal ions.

The negative electrode active material particles 205 may be particles containing the oxyhalide material according to the first embodiment or particles containing the oxyhalide material according to the first embodiment as a main component.

When having the above configuration, the battery 1000 has high energy density.

The negative electrode active material particles 205 may be particles containing a different material from the oxyhalide material according to the first embodiment or negative electrode active material particles containing a material other than the oxyhalide material according to the first embodiment as a main component. The negative electrode active material is called a second negative electrode active material. That is, the negative electrode active material particles 205 may contain the second negative electrode active material.

Examples of the second negative electrode active material include metallic materials, carbon materials, oxides, nitrides, tin compounds, and silicon compounds. The metallic materials may be a single metal or an alloy. Examples of the metallic materials include lithium metal and lithium alloys. Examples of the carbon materials include natural graphite, coke, graphitizing carbon, carbon fiber, spherical carbon, artificial graphite, and amorphous carbon. From the viewpoint of capacity density, preferred examples of the negative electrode active material include silicon (that is, Si), tin (that is, Sn), silicon compounds, and tin compounds.

As the negative electrode active material particles 205, a mixture of particles containing the oxyhalide material according to the first embodiment and particles containing the second negative electrode active material may be used.

The negative electrode active material particles 205 may have a median diameter of greater than or equal to 0.1 μm and less than or equal to 100 μm. When the negative electrode active material particles 205 have a median diameter of greater than or equal to 0.1 μm, the negative electrode active material particles 205 and the solid electrolyte particles 100 can be well dispersed in the negative electrode 203. This improves the charge-discharge characteristics of the battery. When the negative electrode active material particles 205 have a median diameter of less than or equal to 100 μm, a lithium diffusion rate within the negative electrode active material particles 205 improves. This can cause the battery 1000 to operate at high output.

The negative electrode active material particles 205 may have a larger median diameter than that of the solid electrolyte particles 100. With this, the negative electrode active material particles 205 and the solid electrolyte particles 100 can be well dispersed in the negative electrode 203.

To increase the energy density and the output of the battery, in the negative electrode 203, the ratio of the volume of the negative electrode active material particles 205 to the total of the volume of the negative electrode active material particles 205 and the volume of the solid electrolyte particles 100 may be greater than or equal to 0.30 and less than or equal to 0.95.

To increase the energy density and the output, the negative electrode 203 may have a thickness of greater than or equal to 10 μm and less than or equal to 500 μm.

At least one selected from the group consisting of the positive electrode 201 and the negative electrode 203 may contain the oxyhalide material according to the first embodiment as an active material and does not necessarily contain any active materials other than the oxyhalide material according to the first embodiment. With the above configuration, the oxyhalide material plays a role as not only the electrolyte but also the active material, and thus the energy density of the battery 1000 can be improved.

At least one selected from the group consisting of the positive electrode 201, the electrolyte layer 202, and the negative electrode 203 may contain the second solid electrolyte material for the purpose of increasing ionic conductivity, chemical stability, and electrochemical stability.

At least one selected from the group consisting of the positive electrode 201, the electrolyte layer 202, and the negative electrode 203 may contain a nonaqueous electrolyte solution, a gel electrolyte, or an ionic liquid for the purpose of facilitating delivery of lithium ions and improving the output characteristics of the battery 1000.

The nonaqueous electrolyte solution contains a nonaqueous solvent and a lithium salt dissolved in the nonaqueous solvent.

Examples of the nonaqueous solvent include cyclic carbonate solvents, chain-like carbonate solvents, cyclic ether solvents, chain-like ether solvents, cyclic ester solvents, chain-like ester solvents, and fluorine solvents. Examples of the cyclic carbonate solvents include ethylene carbonate, propylene carbonate, and butylene carbonate. Examples of the chain-like carbonate solvents include dimethyl carbonate, ethylmethyl carbonate, and diethyl carbonate. Examples of the cyclic ether solvents include tetrahydrofuran, 1,4-dioxane, and 1,3-dioxolane. Examples of the chain-like ether solvents include 1,2-dimethoxyethane and 1,2-diethoxyethane. Examples of the cyclic ester solvents include γ-butyrolactone. Examples of the chain-like ester solvents include methyl acetate. Examples of the fluorine solvents include fluoroethylene carbonate, fluoromethyl propionate, fluorobenzene, fluoroethylmethyl carbonate, and fluorodimethylene carbonate. One nonaqueous solvent selected from these may be used singly. Alternatively, a mixture of two or more nonaqueous solvents selected from these may be used.

Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these may be used singly. Alternatively, a mixture of two or more lithium salts selected from these may be used. The concentration of the lithium salt is, for example, greater than or equal to 0.5 mol/L and less than or equal to 2 mol/L.

As the gel electrolyte, polymer materials impregnated with a nonaqueous electrolyte solution can be used. Examples of the polymer materials include polyethylene oxide, polyacrylonitrile, polyvinylidene fluoride, polymethylmethacrylate, and polymers having an ethylene oxide bond.

Examples of cations contained in the ionic liquid include:
(i) aliphatic chain-like quarternary salts such as tetraalkylammonium and tetraalkylphosphonium,
(ii) aliphatic cyclic ammonium such as pyrrolidiniums, morpholiniums, imidazoliniums, tetrahydropyrimidiniums, piperaziniums, and piperidiniums, and
(iii) nitrogen-containing heterocyclic cations such as pyridiniums and imidazoliums.

Examples of anions contained in the ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving adhesion among the particles.

Examples of the binder include polyvinylidene fluoride, polytetrafluoroethylene, polyethylene, polypropylene, aramid resins, polyamide, polyimide, polyamideimide, polyacrylonitrile, polyacrylic acid, polymethylacrylate, polyethylacrylate, polyhexylacrylate, polymethacrylic acid, polymethylmethacrylate, polyethylmethacrylate, polyhexylmethacrylate, polyvinyl acetate, polyvinylpyrrolidone, polyether, polyethersulfone, hexafluoropolypropylene, styrene butadiene rubber, and carboxymethylcellulose. Copolymers can also be used as the binder. Examples of such a binder include copolymers of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more selected from the above materials may be used as the binder.

At least one selected from the positive electrode 201 and the negative electrode 203 may contain a conductive aid in order to increase electron conductivity.

Examples of the conductive aid include:
(i) graphites such as natural graphite and artificial graphite,
(ii) carbon blacks such as acetylene black and ketjen black,
(iii) conductive fibers such as carbon fibers and metallic fibers,
(iv) carbon fluoride,
(v) metallic powders such as aluminum,
(vi) conductive whiskers such as zinc oxide and potassium titanate,
(vii) conductive metal oxides such as titanium oxide, and
(viii) conductive polymer compounds such as polyaniline, polypyrrole, and polythiophene.
For reduced costs, the (i) or (ii) conductive aid above may be used.

Examples of the shape of the battery 1000 according to the second embodiment include a coin shape, a tubular shape, a rectangular shape, a sheet shape, a button shape, a flat shape, and a laminated shape.

The battery 1000 according to the second embodiment may be produced by, for example, preparing a material for forming the positive electrode, a material for forming the electrolyte layer, and a material for forming the negative electrode and producing a stacked body in which the positive electrode, the electrolyte layer, and the negative electrode are stacked on each other in this order by a known method.

The battery 1000 according to the second embodiment may be used, for example, with a lower potential limit for discharge of less than or equal to 3.0 V to the standard electrode potential of Li metal. That is, a battery system including the battery 1000 according to the second embodiment may have a lower potential limit for discharge of less than or equal to 3.0 V to the standard electrode potential of Li metal. With the above configuration, the oxidation-reduction reaction of the oxyhalide material according to the first embodiment can contribute to the charge-discharge reaction of the battery 1000 according to the second embodiment. Thus, the charge-discharge capacity and the energy density of the battery 1000 can improve.

### EXAMPLES

The following describes the present disclosure in more detail with reference to examples and comparative examples.

### Example 1-1

### Production of Oxyhalide Material

In an argon atmosphere having a dew point of lower than or equal to −60° C. (hereinafter referred to as a “dry argon atmosphere”), Li₂O₂, TaCl₅, TaF₅, and NbCl₅ as raw material powders were mixed together so as to have a molar ratio of Li₂O₂:TaCl₅:TaF₅:NbCl₅=0.60:0.46:0.04:0.50 to obtain a mixture. Subsequently, using a planetary ball mill (manufactured by Fritsch GmbH, Type P-7), the mixture was subjected to milling processing on the conditions of 12 hours and 600 rpm. Next, the processed mixture was put into an alumina crucible and was heat-treated on the conditions of 170° C. and 3 hours in the dry argon atmosphere. The obtained heat-treated product was pulverized in an agate mortar. Thus, a powder of an oxyhalide material of Example 1-1 was produced.

Table 1 lists the constituting elements, the molar ratio of Nb to M (that is, the Nb/M molar ratio), and the molar ratio of F to X (that is, the F/X molar ratio) of the oxyhalide material of Example 1-1. M represents a Group 5 element. In Example 1-1, M is the total of Ta and Nb. X represents a halogen element. In Example 1-1, X is the total of Cl and F.

For the oxyhalide material of Example 1-1, the Nb/M molar ratio was 0.50, the F/X molar ratio was 0.04, the Li/M molar ratio was 1.2, and the O/X molar ratio was 0.24, which were calculated from the molar ratio of the raw material powders mixed together.

### Evaluation of Lithium-Ionic Conductivity

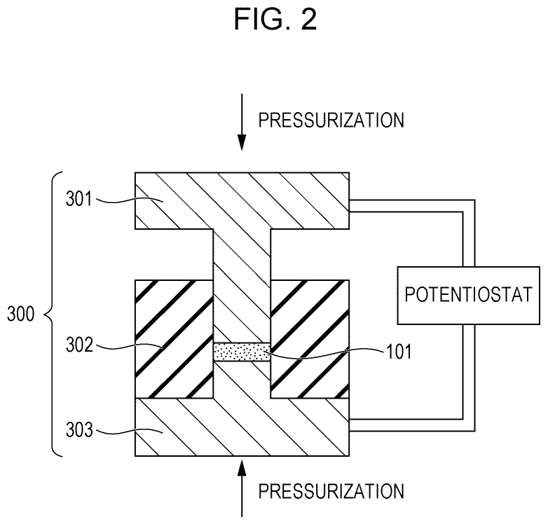

FIG. 2 is a schematic diagram of a molding die 300 used for evaluating a lithium-ionic conductivity of the oxyhalide material of Example 1-1.

The molding die 300 included a punch upper part 301, a die 302, and a punch lower part 303. Both the punch upper part 301 and the punch lower part 303 were formed of electron conductive stainless. The die 302 was formed of insulating polycarbonate.

Using the molding die 300 illustrated in FIG. 2, the lithium-ionic conductivity of the oxyhalide material of Example 1-1 was evaluated by the following method.

In the dry argon atmosphere, the inside of the molding die 300 was filled with a powder 101 of the oxyhalide material of Example 1-1. Inside the molding die 300, a pressure of 360 MPa was applied to the powder 101 of the oxyhalide material of Example 1-1 using the punch upper part 301 and the punch lower part 303.

With the pressure remained applied, the punch upper part 301 and the punch lower part 303 were connected to a potentiostat (Princeton Applied Research, VersaSTAT4) installed with a frequency response analyzer. The punch upper part 301 was connected to a working electrode and a potential measuring terminal. The punch lower part 303 was connected to a counter electrode and a reference electrode. The impedance of the oxyhalide material was measured by an electrochemical impedance measurement method at room temperature (25° C.).

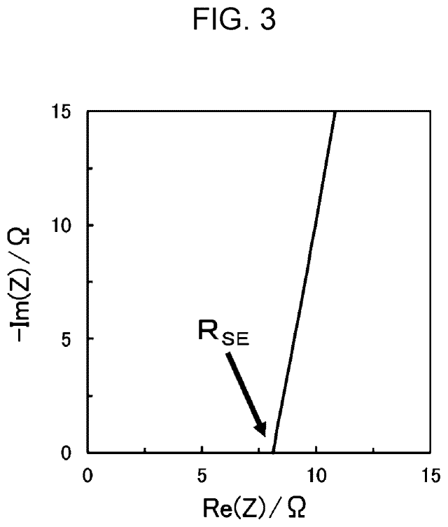

FIG. 3 is a graph of a Cole-Cole plot obtained by the impedance measurement on the oxyhalide material of Example 1-1. The vertical axis shows the imaginary part of complex impedance, and the horizontal axis shows the real part of complex impedance.

In FIG. 3, the real number value of the impedance at a measurement point with the smallest absolute value of the phase of the complex impedance was regarded as a resistance value for the ionic conductivity of the oxyhalide material. For the real number value, refer to the arrow R_{SE} indicated in FIG. 3. Using the resistance value, lithium-ionic conductivity was calculated based on Numerical Formula (2) below:

$$σ = {( {R}_{S E} \times S / t )}^{- 1} \qquad Formula ( 2 )$$

Here, σ represents lithium-ionic conductivity. S represents the contact area of the oxyhalide material with the punch upper part 301 (which is equal to the sectional area of the hollow part of the die 302 in FIG. 2). R_{SE} represents the resistance value of the oxyhalide material in the impedance measurement. The letter t represents the thickness of the oxyhalide material (that is, in FIG. 2, the thickness of the layer formed of the powder 101 of the oxyhalide material).

The lithium-ionic conductivity of the oxyhalide material of Example 1-1 measured at 25° C. was 7.4×10⁻³ S/cm. Table 1 lists the measurement result.

### X-Ray Diffraction Measurement

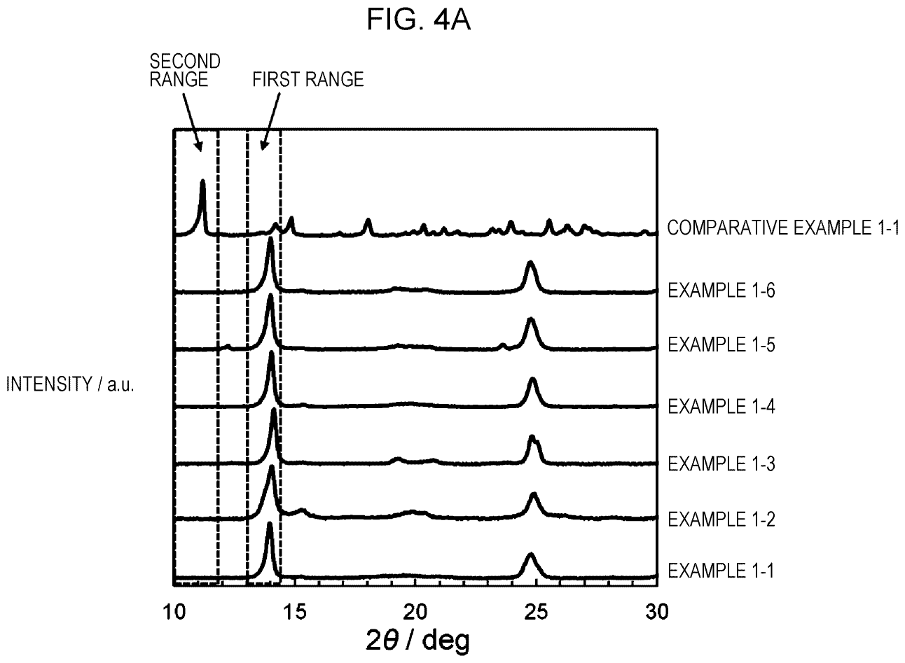

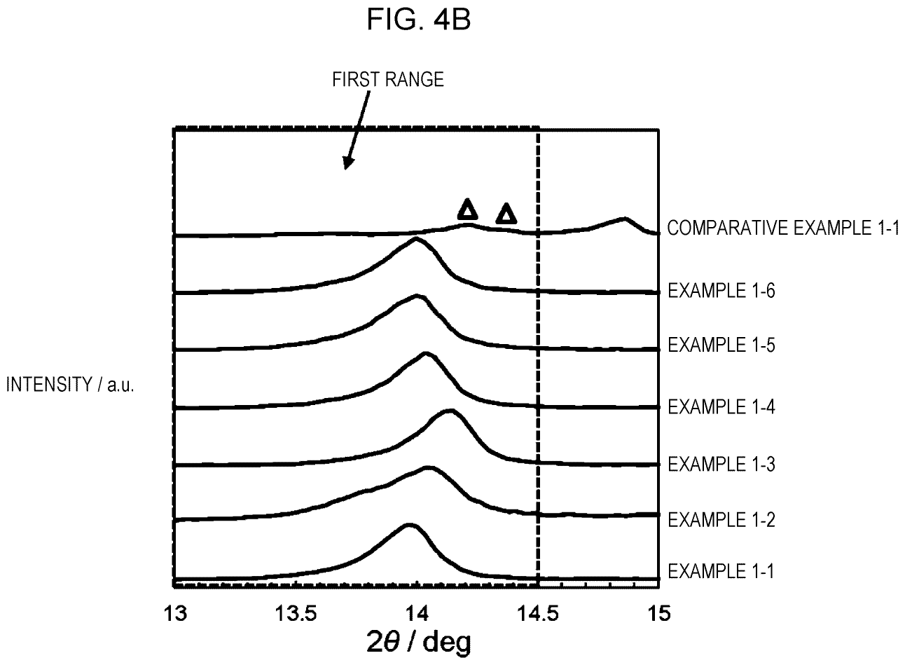

FIG. 4A is a graph of an X-ray diffraction pattern of the oxyhalide material of Example 1-1. FIG. 4B is an enlarged view of the first range in FIG. 4A. In FIG. 4A and FIG. 4B, the vertical axis shows diffraction X-ray intensity, and the horizontal axis shows diffraction angle (2θ). The-X-ray diffraction pattern was measured by the following procedure.

In a dry environment having a dew point of lower than or equal to −50° C., using an X-ray diffraction apparatus (Rigaku Corporation, MiniFlex 600), the X-ray diffraction pattern of the oxyhalide material of Example 1-1 was measured by the θ-2θ method. As an X-ray source, Cu-Kα radiation (wavelengths of 1.5405 Å and 1.5444 Å) was used.

In the diffraction pattern of the oxyhalide material of Example 1-1, at least one peak was present in the first range with a diffraction angle 2θ of greater than or equal to 13.0° and less than or equal to 14.5°. No peak was present in the second range with a diffraction angle 2θ of greater than or equal to 10.0° and less than or equal to 11.9°.

### Cyclic Voltammetric Measurement

The electrochemical stability of the oxyhalide material of Example 1-1 was evaluated by cyclic voltammetric measurement (CV measurement).

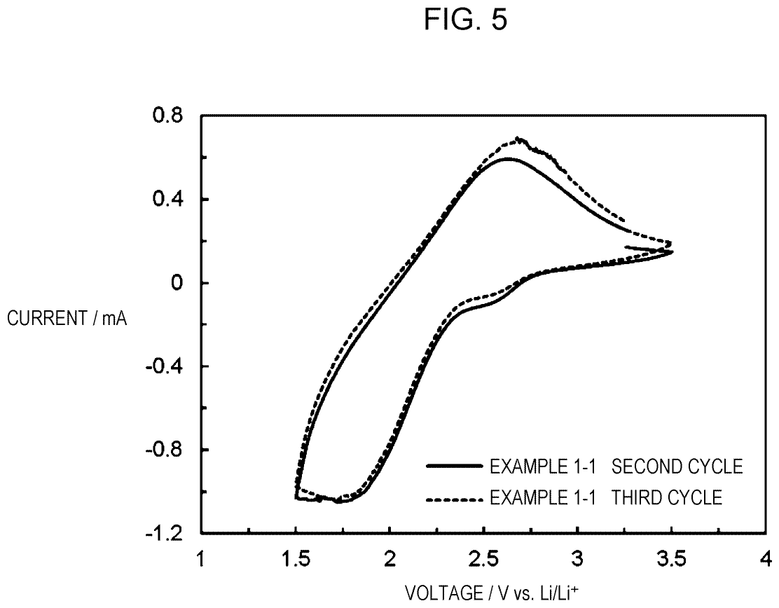

FIG. 5 is a graph of cyclic voltammograms at a second cycle and a third cycle obtained by the CV measurement on the oxyhalide material according to Example 1-1. The vertical axis shows response current value, and the horizontal axis shows applied potential.

First, a cell for CV measurement was produced by the method described below.

In the dry argon atmosphere, the oxyhalide material of Example 1-1 and a SUS powder were prepared so as to have a volume ratio of 50:50. These materials were mixed together in an agate mortar to obtain a mixed powder of Example 1-1.

In an insulating tube having an inner diameter of 9.5 mm, a glass ceramic sulfide solid electrolyte Li₂S—P₂S₅ (60 mg) and a halide solid electrolyte Li₃YBr₂Cl₄ (20 mg) as a solid electrolyte layer, and the mixed powder of Example 1-1 (20 mg) as a working electrode were stacked on each other in this order to form a stacked body. A pressure of 720 MPa was applied to this stacked body.

Next, Li metal having a thickness of 200 μm was stacked on the solid electrolyte layer of the stacked body. A pressure of 80 MPa was applied to this stacked body to form a counter electrode and a reference electrode.

Next, a collector formed of stainless steel was attached to the counter electrode and the reference electrode, and collector leads were attached to the collectors.

Finally, using an insulating ferrule, the inside of the insulating tube was insulated from the external atmosphere to hermetically seal the inside of the tube. A cell for CV measurement of Example 1-1 was thus produced.

The obtained cell for CV measurement was placed in a 25° C. thermostat oven.

The CV measurement was performed by the following procedure.

First, the potential was swept from an open-circuit voltage (about 3.26 V to the standard electrode potential of Li metal) to 1.5 V to the standard electrode potential of Li metal at a scanning voltage rate of −2 mV/second.

Next, the potential was swept to 3.5 V to the standard electrode potential of Li metal at a scanning voltage rate of 2 mV/second.

Subsequently, the potential was swept to the initial open-circuit voltage (about 3.2 V to the standard electrode potential of Li metal) at a scanning voltage rate of −2 mV/second.

By the above procedure, a cyclic voltammogram at a first cycle was obtained.

In the same manner as in the first cycle, cyclic voltammograms at a second cycle and a third cycle were obtained.

The total current amount of the cyclic voltammogram at each cycle was determined by integrating the absolute value of the current amount of the cyclic voltammogram obtained at each cycle.

In the oxyhalide material of Example 1-1, a total current amount A₃ at the third cycle to a total current amount A₂ at the second cycle, that is the value obtained by 100×(A₃/A₂) was 102%. It can be said that the smaller the change rate of the total current amount A₃ at the third cycle to the total current amount A₂ at the second cycle, the higher reversibility of the oxidation-reduction reaction the oxyhalide material showed. In other words, it can be said that the closer to 100% the value obtained by 100×(A₃/A₂) is, the higher reversibility of the oxidation-reduction reaction the oxyhalide material showed.

X-Ray Diffraction Measurement after CV Measurement

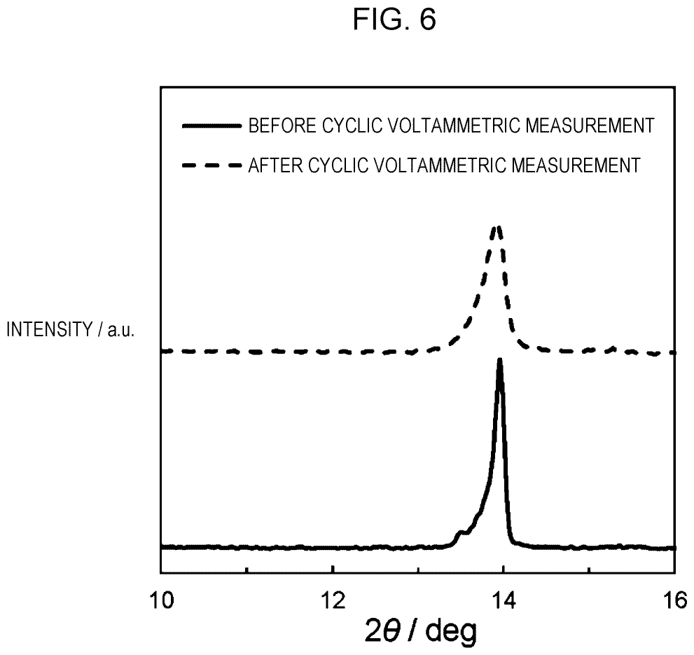

FIG. 6 is a graph of X-ray diffraction patterns of the oxyhalide material of Example 1-1 before and after performing the CV measurement on 11 cycles. The vertical axis shows diffraction X-ray intensity, and the horizontal axis shows diffraction angle (2θ).

The X-ray diffraction patterns were obtained by the procedure described in the section X-ray Diffraction Measurement above.

As illustrated in FIG. 6, in the diffraction patterns of the oxyhalide material of Example 1-1, before and after performing the CV measurement on 11 cycles, there was a slight decrease in the diffraction angle of the peak and a slight reduction in the intensity thereof. Meanwhile, there was neither the occurrence of a new peak nor the disappearance of the peak.

### Examples 1-2 to 1-6

### Production of Oxyhalide Material

In Example 1-2, Li₂O₂, TaCl₅, TaF₅, and NbCl₅ as raw material powders were mixed together so as to have a molar ratio of Li₂O₂:TaCl₅:TaF₅:NbCl₅=0.60:0.46:0.02:0.50.

For the oxyhalide material of Example 1-2, the Nb/M molar ratio was 0.50, the F/X molar ratio was 0.02, the Li/M molar ratio was 1.2, and the O/X molar ratio was 0.24, which were calculated.

In Example 1-3, Li₂O₂, TaCl₅, TaF₅, and NbCl₅ as raw material powders were mixed together so as to have a molar ratio of Li₂O₂:TaCl₅:TaF₅:NbCl₅=0.60:0.42:0.08:0.50.

For the oxyhalide material of Example 1-3, the Nb/M molar ratio was 0.50, the F/X molar ratio was 0.08, the Li/M molar ratio was 1.2, and the O/X molar ratio was 0.24, which were calculated.

In Example 1-4, Li₂O₂, TaCl₅, TaF₅, and NbCl₅ as raw material powders were mixed together so as to have a molar ratio of Li₂O₂:TaCl₅:TaF₅:NbCl₅=0.60:0.41:0.04:0.55.

For the oxyhalide material according to Example 1-4, the Nb/M molar ratio was 0.55, the F/X molar ratio was 0.04, the Li/M molar ratio was 1.2, and the O/X molar ratio was 0.24, which were calculated.

In Example 1-5, Li₂O₂, TaCl₅, TaF₅, and NbCl₅ as raw material powders were mixed together so as to have a molar ratio of Li₂O₂:TaCl₅:TaF₅:NbCl₅=0.60:0.36:0.04:0.60.

For the oxyhalide material of Example 1-5, the Nb/M molar ratio was 0.60, the F/X molar ratio was 0.04, the Li/M molar ratio was 1.2, and the O/X molar ratio was 0.24, which were calculated.

In Example 1-6, Li₂O₂, TaCl₅, TaF₅, and NbCl₅ as raw material powders were mixed together so as to have a molar ratio of Li₂O₂:TaCl₅:TaF₅:NbCl₅=0.60:0.26:0.04:0.70.

For the oxyhalide material of Example 1-6, the Nb/M molar ratio was 0.70, the F/X molar ratio was 0.04, the Li/M molar ratio was 1.2, and the O/X molar ratio was 0.24, which were calculated.

The oxyhalide materials of Examples 1-2 to 1-6 were produced in the same manner as in Example 1-1 except the above matter. Table 1 lists the constituting elements, the Nb/M molar ratio, and the F/X molar ratio of the oxyhalide materials of Examples 1-2 to 1-6.

### Evaluation of Lithium-Ionic Conductivity

Lithium-ionic conductivities of the oxyhalide materials of Examples 1-2 to 1-6 were measured in the same manner as in Example 1-1. Table 1 lists the measurement results.

### X-Ray Diffraction Measurement

X-ray diffraction patterns of the oxyhalide materials of Examples 1-2 to 1-6 were measured in the same manner as in Example 1-1. FIG. 4A and FIG. 4B illustrate the measurement results.

In the X-ray diffraction patterns of the oxyhalide materials of Examples 1-2 to 1-6, at least one peak was present in the first range with a diffraction angle 2θ of greater than or equal to 13.0° and less than or equal to 14.5°. No peak was present in the second range with a diffraction angle 2θ of greater than or equal to 10.0° and less than or equal to 11.9°.

### Cyclic Voltammetric Measurement

Cyclic voltammograms at a first cycle to a third cycle were each obtained for the oxyhalide materials of Examples 1-2 to 1-6 in the same manner as in Example 1-1. Based on the obtained cyclic voltammograms, the total current amount A₃ at the third cycle to the total current amount A₂ at the second cycle (100×(A₃/A₂)) was determined. Table 1 lists the values of 100×(A₃/A₂).

### X-Ray Diffraction Measurement after CV Measurement

X-ray diffraction patterns before and after performing the CV measurement on 11 cycles were measured for the oxyhalide materials of Examples 1-2 to 1-6 in the same manner as in Example 1-1.

The presentation of the X-ray diffraction patterns is omitted. In the diffraction patterns of the oxyhalide materials of Examples 1-2 to 1-6, as in Example 1-1, before and after performing the CV measurement on 11 cycles, there was a slight decrease in the diffraction angle of the peak and a slight reduction in the intensity thereof. Meanwhile, there was neither the occurrence of a new peak nor the disappearance of the peak.

### Comparative Example 1-1

### Production of Oxyhalide Material

In Comparative Example 1-1, Li₂O₂ and TaCl₅ as raw material powders were mixed together so as to have a molar ratio of Li₂O₂:TaCl₅=0.60:1.00 to obtain a mixture. Subsequently, using a planetary ball mill (manufactured by Fritsch GmbH, Type P-7), the mixture was subjected to milling processing on the conditions of 12 hours and 600 rpm. Next, the processed mixture was put into an alumina crucible and was heat-treated on the conditions of 200° C. and 3 hours in the dry argon atmosphere. The obtained heat-treated product was pulverized in an agate mortar. Thus, a powder of an oxyhalide material of Comparative Example 1-1 was produced.

Table 1 lists the constituting elements, the Nb/M molar ratio, and the F/X molar ratio of the oxyhalide material of Comparative Example 1-1.

### Evaluation of Lithium-Ionic Conductivity

A lithium-ionic conductivity of the oxyhalide material of Comparative Example 1-1 was measured in the same manner as in Example 1-1. Table 1 lists the measurement result.

### X-Ray Diffraction Measurement

An X-ray diffraction pattern of the oxyhalide material of Comparative Example 1-1 was measured in the same manner as in Example 1-1. FIG. 4A and FIG. 4B illustrate the measurement result. FIG. 4B is an enlarged view of the first range in FIG. 4A. In FIG. 4B, Δ indicated in the diffraction pattern of the oxyhalide material of Comparative Example 1-1 represents the positions of peaks.

As illustrated in FIG. 4A and FIG. 4B, in the diffraction pattern of the oxyhalide material of Comparative Example 1-1, two peaks were present in the first range with a diffraction angle 2θ of greater than or equal to 13.0° and less than or equal to 14.5°. In the second range with a diffraction angle 2θ of greater than or equal to 10.0° and less than or equal to 11.9°, two peaks were present. For the oxyhalide material of Comparative Example 1-1, the ratio of the intensity Iₚ₁ of a peak with the highest intensity in the first range to the intensity Iₚ₂ of a peak with the highest intensity in the second range Iₚ₁/Iₚ₂ was calculated. The value of the ratio Iₚ₁/Iₚ₂ was 0.24.

### Cyclic Voltammetric Measurement

Cyclic voltammograms at a first cycle to a third cycle were obtained for the oxyhalide material of Comparative Example 1-1 in the same manner as in Example 1-1. Based on the obtained cyclic voltammograms, the total current amount A₃ at the third cycle to the total current amount A₂ at the second cycle (100×(A₃/A₂)) was determined. Table 1 lists the value of 100×(A₃/A₂).

TABLE 1

| | | | | | Lithium- |
|---|---|---|---|---|---|
| | | | | 100 × | ionic |
| | Constituting | | | (A₃/A₂) | conductivity |
| | elements | Nb/M | F/X | (%) | (S/cm) |
| Example 1-1 | Li, Ta, Nb, | 0.50 | 0.04 | 102 | 7.4 × 10⁻³ |
| | O, Cl, F | | | | |
| Example 1-2 | Li, Ta, Nb, | 0.50 | 0.02 | 95 | 4.0 × 10⁻³ |
| | O, Cl, F | | | | |
| Example 1-3 | Li, Ta, Nb, | 0.50 | 0.08 | 93 | 5.9 × 10⁻³ |
| | O, Cl, F | | | | |
| Example 1-4 | Li, Ta, Nb, | 0.55 | 0.04 | 99 | 6.8 × 10⁻³ |
| | O, Cl, F | | | | |
| Example 1-5 | Li, Ta, Nb, | 0.60 | 0.04 | 99 | 5.7 × 10⁻³ |
| | O, Cl, F | | | | |
| Example 1-6 | Li, Ta, Nb, | 0.70 | 0.04 | 93 | 5.9 × 10⁻³ |
| | O, Cl, F | | | | |
| Comparative | Li, Ta, O, | 0 | 0 | 133 | 7.8 × 10⁻³ |
| Example 1-1 | Cl | | | | |

In Examples 2-1 to 2-6 and Comparative Example 2-1 below, batteries were produced using the oxyhalide materials of Examples 1-1 to 1-6 and Comparative Example 1-1 as solid electrolytes.

### Example 2-1

### Production of Battery

In the dry argon atmosphere, the oxyhalide material of Example 1-1 and Li(Ni,Co,Al)O₂ (hereinafter referred to as “NCA”) were prepared so as to have a volume ratio of 30:70. These materials were mixed together in a mortar to obtain a positive electrode material.

In an insulating tube having an inner diameter of 9.5 mm, a glass ceramic sulfide solid electrolyte Li₂S—P₂S₅ (80 mg), a halide solid electrolyte Li₃YBr₂Cl₄ (15 mg), and the above positive electrode material were stacked on each other in this order. The mass of the positive electrode material was adjusted such that the amount of NCA contained in the positive electrode material was 7 mg. A pressure of 720 MPa was applied to the obtained stacked body to form a solid electrolyte layer and a positive electrode containing the positive electrode material.

Next, Li metal (thickness: 200 μm) was stacked on the solid electrolyte layer. A pressure of 80 MPa was applied to the obtained stacked body to obtain a negative electrode.

Next, a collector formed of stainless steel was attached to the positive electrode and the negative electrode, and collector leads were attached to the collectors.

Finally, using an insulating ferrule, the inside of the insulating tube was insulated from the external atmosphere to hermetically seal the inside of the tube. A battery of Example 2-1 was thus produced.

### Charge-Discharge Test

The charge-discharge characteristics of the battery were evaluated by the following method.

The battery of Example 2-1 was placed in a 25° C. thermostat oven.

First, charge-discharge characteristics at a first cycle were evaluated. With a current value of 70 μA, the battery of Example 2-1 was charged with a constant current until a voltage of 4.3 V was reached. The current value corresponds to 0.05 C rate.

Next, with a current value of 70 μA, the battery of Example 2-1 was discharged with a constant current until a voltage of 2.5 V was reached. The current value corresponds to 0.05 C rate.

Subsequently, charge-discharge characteristics at a second cycle were evaluated. With a current value of 140 μA, the battery of Example 2-1 was charged with a constant current until a voltage of 4.3 V was reached. The current value corresponds to 0.1 C rate.

Next, with a current value of 140 μA, the battery of Example 2-1 was discharged with a constant current until a voltage of 2.5 V was reached. The current value corresponds to 0.1 C rate.

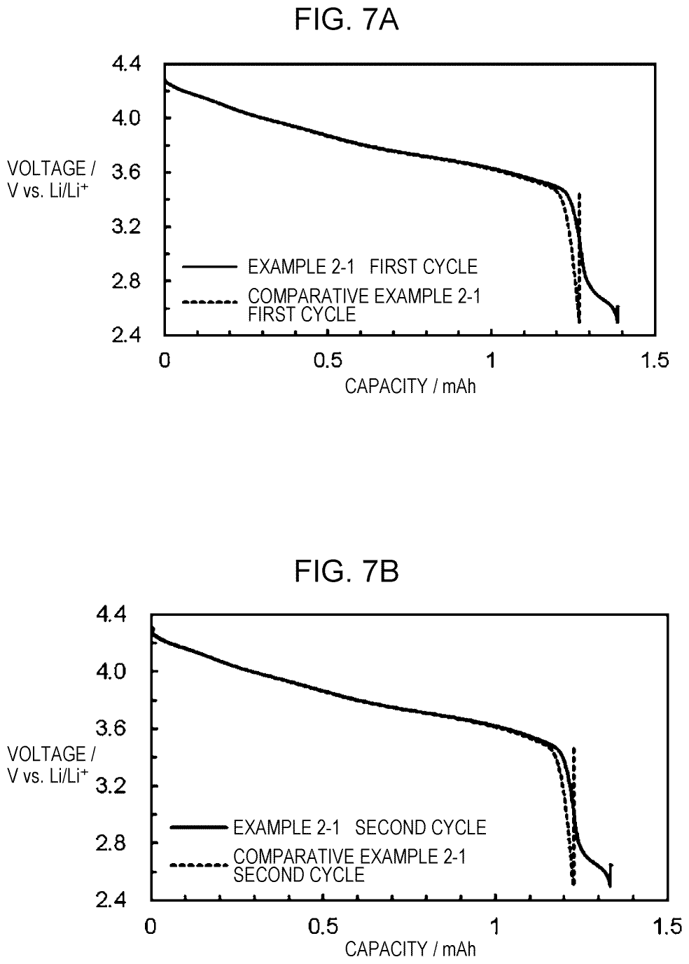

FIG. 7A and FIG. 7B are graphs of the discharge characteristics of the battery of Example 2-1 at the first cycle and the second cycle, respectively. The vertical axis shows voltage, and the horizontal axis shows discharge capacity.

In the results of the charge-discharge test, the battery of Example 2-1 had a discharge capacity of 1.39 mAh at the first cycle and had a discharge capacity of 1.34 mAh at the second cycle.

### Examples 2-2 to 2-6

Using the oxyhalide materials of Examples 1-2 to 1-6, batteries of Examples 2-2 to 2-6 were obtained in the same manner as in Example 2-1. Using the batteries of Examples 2-2 to 2-6, charge-discharge tests were performed in the same manner as in Example 2-1. Consequently, the batteries of Examples 2-2 to 2-6 were well charged and discharged as in the battery according to Example 2-1.

### Comparative Example 2-1

Using the oxyhalide material of Comparative Example 1-1, a battery of Comparative Example 2-1 was obtained in the same manner as in Example 2-1. Using the battery of Comparative Example 2-1, a charge-discharge test was performed in the same manner as in Example 2-1.

FIG. 7A illustrates the discharge characteristics of the battery of Comparative Example 2-1 at the first cycle together with the discharge characteristics of the battery of Example 2-1 at the first cycle. FIG. 7B illustrates the discharge characteristics of the battery of Comparative Example 2-1 at the second cycle together with the discharge characteristics of the battery of Example 2-1 at the second cycle.

The battery of Comparative Example 2-1 had a discharge capacity of 1.27 mAh at the first cycle and had a discharge capacity of 1.23 mAh at the second cycle.

In Example 3-1 below, a battery was produced with the oxyhalide material of Example 1-1 used as an active material.

### Example 3-1

### Production of Battery

In the dry argon atmosphere, the oxyhalide material of Example 1-1 and a halide solid electrolyte Li₃YBr₂Cl₄ were prepared so as to have a volume ratio of 70:30. Furthermore, carbon fibers (manufactured by Showa Denko K.K., VGCF-H) as a conductive aid were prepared so as to be 10% by mass with respect to the oxyhalide material. These materials were mixed together in a mortar to obtain a positive electrode material. Note that “VGCF” is a registered trademark of Showa Denko K.K.

In an insulating tube having an inner diameter of 9.5 mm, a glass ceramic sulfide solid electrolyte Li₂S-P₂S₅ (80 mg), Li₃YBr₂Cl₄ (15 mg), and the above positive electrode material were stacked on each other in this order. The mass of the positive electrode material was adjusted such that the amount of the oxyhalide material contained in the positive electrode material was 7 mg. A pressure of 720 MPa was applied to the obtained stacked body to form a solid electrolyte layer and a positive electrode containing the positive electrode material.

Next, Li metal (thickness: 200 μm) was stacked on the solid electrolyte layer. A pressure of 80 MPa was applied to the obtained stacked body to obtain a negative electrode.

Next, a collector formed of stainless steel was attached to the positive electrode and the negative electrode, and collector leads were attached to the collectors.

Finally, using an insulating ferrule, the inside of the insulating tube was insulated from the external atmosphere to hermetically seal the inside of the tube. A battery of Example 3-1 was thus obtained.

### Charge-Discharge Test

The charge-discharge characteristics of the battery were evaluated by the following method.

The battery of Example 3-1 was placed in a 25° C. thermostat oven.

First, charge-discharge characteristics at a first cycle were evaluated. With a current value of 63 μA, the battery of Example 3-1 was discharged with a constant current until a voltage of 2.45 V was reached. The current value corresponds to 0.2 C rate.

Next, with a current value of 63 μA, the battery of Example 3-1 was charged with a constant current until a voltage of 3.00 V was reached. The current value corresponds to 0.2 C rate.

Charge-discharge characteristics at second to 50th cycles were measured in the same manner as in the first cycle.

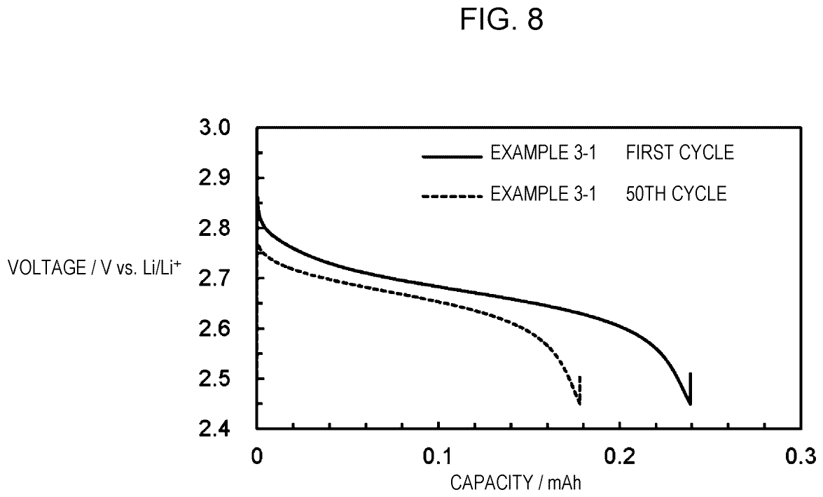

FIG. 8 is a graph of the discharge characteristics of the battery of Example 3-1 at the first cycle and the 50th cycle.

In the charge-discharge test, the battery of Example 3-1 had a discharge capacity of 0.24 mAh at the first cycle and had a discharge capacity of 0.18 mAh at the 50th cycle.

### Consideration

As listed in Table 1, the oxyhalide materials of Examples 1-1 to 1-6 showed a high lithium-ionic conductivity of greater than or equal to 1.0×10⁻³ S/cm around room temperature.

In addition, in the oxyhalide materials of Examples 1-1 to 1-6, before and after performing the CV measurement on 11 cycles, there was a slight decrease in the diffraction angle of the peak and a slight reduction in the intensity thereof, but there was neither the occurrence of a new peak nor the disappearance of the peak (refer to FIG. 6). This means that the oxyhalide materials of Examples 1-1 to 1-6 showed a reversible oxidation-reduction reaction. That is, the oxyhalide materials of Examples 1-1 to 1-6 had high electrochemical stability.

As illustrated in FIG. 4A and FIG. 4B, the oxyhalide materials of Examples 1-1 to 1-6 had at least one peak in the first range with a diffraction angle 2θ of greater than or equal to 13.0° and less than or equal to 14.5° but had no peak in the second range with a diffraction angle 2θ of greater than or equal to 10.0° and less than or equal to 11.9° in the X-ray diffraction patterns. In contrast, in the oxyhalide material of Comparative Example 1-1, there were two peaks in the first range and there were two peaks in the second range in the X-ray diffraction pattern. More specifically, in the oxyhalide material of Comparative Example 1-1, the ratio Iₚ₁/Iₚ₂ was 0.24. The crystalline phase in which a peak is present in the first range has the one-dimensional chain structure and thus has high reversibility of the oxidation-reduction reaction. In contrast, the crystalline phase in which a peak is present in the second range has lower reversibility of the oxidation-reduction reaction than that of the crystalline phase in which a peak is present in the first range. It is thus considered that the oxyhalide materials of Examples 1-1 to 1-6 have improved in the reversibility of the oxidation-reduction reaction of the oxyhalide materials and have achieved high electrochemical stability compared to Comparative Example 1-1.

In the oxyhalide materials of Examples 1-4 and 1-5, in which the Nb/M molar ratio is greater than or equal to 0.55 and less than or equal to 0.60, the value of 100×(A₃/A₂) was 100%±1%. Thus, the oxyhalide materials of Examples 1-4 and 1-5 showed extremely high reversibility of the oxidation-reduction reaction.

As illustrated in FIG. 7A and FIG. 7B, the battery of Example 2-1, which includes the positive electrode material containing the oxyhalide material having high electrochemical stability as the solid electrolyte, had a higher discharge capacity than that of the battery of Comparative Example 2-1.

Furthermore, as illustrated in FIG. 8, the battery of Example 3-1, which includes the positive electrode material containing the oxyhalide material having high electrochemical stability as the active material, was charged and discharged at room temperature and had high cycle characteristics.

Note that the oxyhalide materials of Examples 1-1 to 1-6 do not contain sulfur, and thus hydrogen sulfide was not produced.

As described above, the oxyhalide material according to the present disclosure has high electrochemical stability in addition to high lithium-ionic conductivity and is thus suitable for providing a battery that can be well charged and discharged.

The oxyhalide material of the present disclosure is used in, for example, batteries (for example, all-solid lithium-ion secondary batteries).

What is claimed is:

1. An oxyhalide material comprising Li, M, O, and X,
M being at least two selected from Group 5 elements,
X being at least one selected from the group consisting of F, Cl, Br, and I, and
the oxyhalide material showing a reversible oxidation-reduction reaction, wherein
in an X-ray diffraction pattern obtained by X-ray diffraction measurement on the oxyhalide material using Cu-Kα radiation, when a range with a diffraction angle 2θ of greater than or equal to 13.0° and less than or equal to 14.5° is defined as a first range, at least one peak is present in the first range, and
in the X-ray diffraction pattern, when a range with a diffraction angle 2θ of greater than or equal to 10.0° and less than or equal to 11.9° is defined as a second range, (A) or (B) below is satisfied:
(A) No peak is present in the second range,
(B) At least one peak is present in the second range, and a ratio of intensity Iₚ₁ of a peak with a highest intensity present in the first range to intensity Iₚ₂ of a peak with a highest intensity present in the second range Iₚ₁/Iₚ₂ is larger than 5.

2. The oxyhalide material according to claim 1, wherein M comprises Nb.

3. The oxyhalide material according to claim 1, wherein M comprises Nb and Ta.

4. The oxyhalide material according to claim 1, wherein X is at least two selected from the group consisting of F, Cl, Br, and I.

5. The oxyhalide material according to claim 4, wherein X comprises F and Cl.

6. The oxyhalide material according to claim 1, wherein when cyclic voltammetric measurement is performed using the oxyhalide material as a working electrode, in a range of greater than or equal to 1.5 V and less than or equal to 4.5 V to a standard electrode potential of Li metal, a total current amount at a third cycle to a total current amount at a second cycle is greater than 90% and less than 110%.

7. The oxyhalide material according to claim 1, wherein when cyclic voltammetric measurement is performed using the oxyhalide material as a working electrode,
in a range of greater than or equal to 1.5 V and less than or equal to 3.5 V to a standard electrode potential of Li metal, a total current amount at a third cycle to a total current amount at a second cycle is greater than 90% and less than 110%.

8. The oxyhalide material according to claim 1, wherein
M comprises Nb,
X comprises F,
a molar ratio of Nb to M is greater than or equal to 0.50 and less than or equal to 0.70, and
a molar ratio of F to X is greater than or equal to 0.02 and less than or equal to 0.08.

9. The oxyhalide material according to claim 8, wherein a molar ratio of Nb to M is greater than or equal to 0.55 and less than or equal to 0.60.

10. A battery comprising:
a positive electrode;
a negative electrode; and
an electrolyte layer provided between the positive electrode and the negative electrode, wherein
at least one selected from the group consisting of the positive electrode, the negative electrode, and the electrolyte layer comprises the oxyhalide material according to claim 1.

11. The battery according to claim 10, wherein at least one selected from the group consisting of the positive electrode and the negative electrode comprises the oxyhalide material.

12. The battery according to claim 11, wherein at least one selected from the group consisting of the positive electrode and the negative electrode comprises the oxyhalide material as an active material and does not comprise any active materials other than the oxyhalide material.

13. A battery system comprising the battery according to claim 10, wherein
a potential limit for discharge of the battery is less than or equal to 3.0 V to a standard electrode potential of Li metal.
